(19) United States
(12) Patent Application Publication
(10) Pub. No.: US 2003/0163395 A1
(43) Pub. Date: Aug. 28, 2003

(54) Information manager

(76) Inventors: Rajesh Patanaik, Fremont, CA (US); Evan D. Goer, Mountain View, CA (US); Mukund Ramadoss, Cupertino, CA (US); Ravikumar Ganapathi, Cupertino, CA (US); Toseef Alam, Fremont, CA (US)

Correspondence Address: B. NOEL KIVLIN, MEYERTONS, HOOD, KIVLIN, KOWERT & GOETZEL, P.C., P. O. BOX 398, AUSTIN,, TX, 78767-0398, US

(21) Appl. No.: 10/080,469

(22) Filed: Feb. 22, 2002

(51) Int. Cl. G06F 17/60

(52) U.S. Cl. 705/28; 705/29

(57) ABSTRACT

The present invention provides a method and apparatus for managing information. The method includes placing a request order to acquire at least one item from an inventory associated with a first location, receiving the item, and providing an indication of receipt of the item. The method further includes reducing the inventory associated with the first location in response to receiving the receipt indication.

### BACKGROUND OF THE INVENTION

1. Field of the Invention

The invention generally relates to managing information for organizations, and, in particular, managing information for a plurality of departments or centers of an organization.

2. Description of the Related Art

For strategic reasons, business entities or individuals (hereinafter referred collectively as “organizations”) commonly establish offices in different cities, states, or countries. Organizations may also establish multiple offices or departments within a same region, such as a city or a building complex. Diversifying to multiple locations allows organizations to serve more customers or clients, for example.

While some organizations may establish a plurality of offices in different locations, these offices may nevertheless work closely with each other. For example, albeit remotely located, various departments or centers of an organization may routinely exchange information, such as status reports, inventory orders, inventory status, resource availability, and the like. As another example, remotely situated departments/centers may also exchange inventory, including loan or purchase inventory from each other.

Facilitating the exchange of information and/or inventory between departments, however, may prove to be a challenging task, as a considerable amount of information or inventory may be exchanged over time. Thus, it may be desirable to have a method and apparatus for exchanging information or inventory between departments or centers of an organization in an efficient manner.

### SUMMARY OF THE INVENTION

In one aspect of the instant invention, a method is provided for managing information. The method includes placing a request order to acquire at least one item from an inventory associated with a first location, receiving the item, and providing an indication of receipt of the item. The method further includes reducing the inventory associated with the first location in response to receiving the receipt indication.

In another aspect of the instant invention, an apparatus is provided for managing information. The apparatus includes a storage unit and a control unit. The storage unit comprises an inventory associated with a first location, wherein the inventory includes at least one item. The control unit is communicatively coupled to the storage unit. The control unit is adapted to provide a request to receive the item from the first location, provide an indication based on receiving the item, and adjust the number of items in the inventory based on detecting the indication.

In yet another aspect of the instant invention, an article comprising one or more machine-readable storage media containing instructions is provided for managing information. The instructions, when executed, enable a processor to provide an order to acquire a resource from a source, wherein the source includes a preselected number of resources, provide an indication based on receiving the item and reduce the preselected number of resources by one based on detecting the indication.

### BRIEF DESCRIPTION OF THE DRAWINGS

The invention may be understood by reference to the following description taken in conjunction with the accompanying drawings, in which like reference numerals identify like elements, and in which:

FIG. 1 is a block diagram of an embodiment of a communications system including a data network;

FIG. 2 is a block diagram of a central system that may be employed in the communications system of FIG. 1 in accordance with one embodiment of the present invention;

FIG. 3 illustrates exemplary contents of a central web page that may be utilized to access the central system of FIG. 2 using a web browser;

FIG. 4 illustrates a block diagram of a remote system that may be employed in the communications system of FIG. 1 in accordance with one embodiment of the present invention;

FIG. 5 depicts a flow diagram of one embodiment of an item management module that may be implemented in the communications system of FIG. 1;

FIG. 6 illustrates an exemplary inventory record that may be employed by the item management module of FIG. 5;

FIG. 7 depicts a flow diagram of one embodiment of an organization management module that may be implemented in the communications system of FIG. 1;

FIG. 8 illustrates a block diagram of a method of accessing an infomanager in the communications system of FIG. 1;

FIG. 9 depicts a flow diagram of one embodiment of a request management module that may be employed in the communications system of FIG. 1;

FIG. 10 illustrates an exemplary manner in which the request management module of FIG. 9 displays resources that are available for completing a customer request;

FIG. 11 depicts a flow diagram of one embodiment of an order management module that may be employed in the communications system of FIG. 1;

FIG. 12 depicts a flow diagram of one embodiment of a rotational equipment module that may be employed in the communications system of FIG. 1; and

FIG. 13 illustrates an exemplary rotational equipment record that may be employed by the rotational equipment module of FIG. 12.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

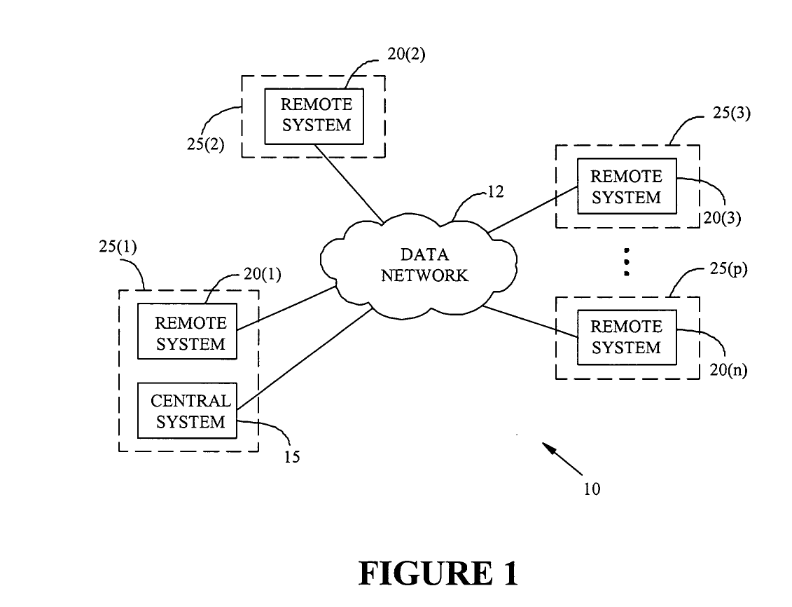

Referring to FIG. 1, a communications system 10 includes a data network 12 that may be coupled to a plurality of systems 15 and 20(1−n) located at various locations 25(1−p). In one embodiment, the various locations 25(1−p) may be representative of different departments or centers of an organization, or, alternatively, different offices of an organization. Thus, for example, the locations 25(1−p), in one embodiment, may represent different offices/centers within a building, within one or more building complexes, within a city or country, and the like. Although not so limited, for illustrative purposes, the remote system 20(1) is shown as residing at the same location 25(1) as the central system 15.

The data network 12 may be a packet-switched data network, such as a data network according to the Internet Protocol (IP). Examples of the data network 12 may include local area networks (LANs), wide area networks (WANs), intranets, and the Internet. One version of IP is described in Request for Comments (RFC) 791, entitled “Internet Protocol,” dated September 1981. Other versions of IP, such as IPv6, or other connectionless, packet-switched standards may also be utilized in further embodiments. A version of IPv6 is described in RFC 2460, entitled “Internet Protocol, Version 6 (IPv6) Specification,” dated December 1998. The data network 12 may also include other types of packet-based data networks in further embodiments. Examples of such other packet-based data networks include Asynchronous Transfer Mode (ATM) and Frame Relay networks.

As utilized herein, a “data network” may refer to one or more communications networks, channels, links, or paths, and systems or devices (such as routers) used to route data over such networks, channels, links, or paths.

The communications system 10 may include, in one embodiment, the central system 15 that is communicatively coupled to one or more remote systems 20(1−n) over the data network 12. The systems 15 and 20(1−n) may be any processor-based systems that are capable of communicating with each other, such as computers, Internet appliances, and the like. Although not shown, one or more of the systems 15 and 20(1−n) may be coupled to the data network 12 through a router (not shown) or gateway (not shown), in one embodiment.

As is described in more detail below, in accordance with one or more embodiments of the present invention, the central system 15 may contain a repository of information for the remote systems 20(1−n) that are located at various respective locations 25(1−p). Thus, in one embodiment, the information of one or more remote systems 20(1−n) may be centrally located in the central system 15. As mentioned earlier, in one embodiment, the locations 25(1−p) may represent different departments /divisions/centers of an organization. The term “information,” as utilized herein, may include any variety of information, including user access profiles, inventory data, reports, or any other type of information that may be useful for the systems 20(1−n). The information for each system 20(1−n), while centrally located in the central system 15, may still be independently maintained, in one embodiment. That is, each system 20(1−n) may have, if desired, a unique database of inventory, users, and the like, for that system 20(1−n).

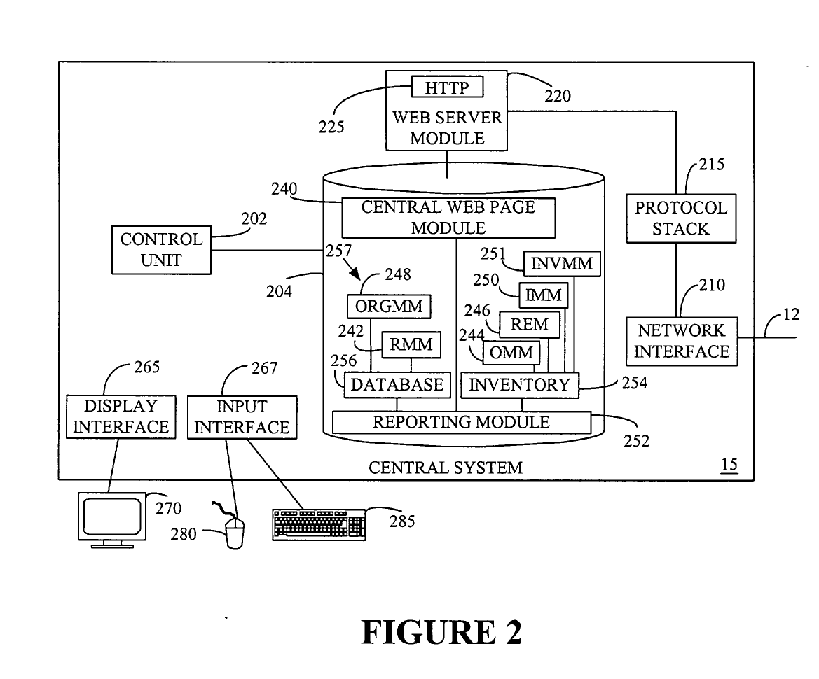

Referring now to FIG. 2, a block diagram of the central system 15 of FIG. 1 in accordance with one embodiment of the present invention is illustrated. The central system 15 includes a control unit 202 that is communicatively coupled to a storage unit 204. The central system 15 includes a network interface 210 that may provide a communications interface to the data network 12. Associated with the network interface 210 may be a network protocol stack 215, with one example being a UDP/IP (User Datagram Protocol/Internet Protocol) stack. UDP is described in RFC 768, entitled “User Datagram Protocol,” dated August 1980. In one embodiment, both inbound and outbound packets may be passed through the network interface 210 and the network protocol stack 215. The arrangement shown in FIG. 2 is provided as an example only, as other embodiments can include other arrangements.

The central system 15, in one embodiment, includes a web server module 220, which may be capable of receiving requests over the data network 12 and responding to such requests. For example, the web server module 220 may include an HTTP (Hypertext Transfer Protocol) service routine 225 that is capable of receiving HTTP requests over the data network 12, as well as sending HTTP responses over the data network 12. HTTP specifies how a client and server may establish a connection, how the client may request data from the server, how the server may respond to the request, and how the connection may be closed. One version of HTTP is described in RFC 2068, entitled “Hypertext Transfer Protocol—HTTP/1.1,” dated January 1997. In one embodiment, the web server module 220 and the HTTP service routine 225 may be stored in the storage unit 204 or in another storage unit (not shown).

The storage unit 204, in one embodiment, may include one or more modules, including a central web page module 240, a request management module (RMM) 242, an order management module (OMM) 244, a rotational equipment module (REM) 246, an organization management module (ORGMM) 248, an item management module (IMM) 250, an inventory management module (INVMM) 251 and reporting module 252. The term “module,” as utilized herein, may be implemented in hardware, software, or a combination thereof.

The storage unit 204, in one embodiment, includes an inventory repository 254 and a database 256. It should be appreciated that although a single inventory repository 254 and database 256 are illustrated in FIG. 2, in one embodiment, a separate inventory repository 254 and/or database 256 may be maintained for each center or organization.

One or more of the aforementioned modules, inventory repository 254, and database 256, individually or collectively, form an infomanager 257. The modules 242, 244, 246, 248, 250, 251, 252, as well as the database 256 and the inventory repository 254, are described in more detail below. Generally, the request management module 242 tracks customer requests (also referred to as “benchmark requests”), displays customer request information, and schedules engineers, hardware, and other resources that are needed to complete the customer request. It will be appreciated that the type of “customer requests” that may be received depends on the particular application. For example, in the context of a computer supplier, a customer may request the computer supplier to show that its computer product or products can perform selected tasks that are desired by the customer.

The order management module 244 generally tracks and processes inventory orders for various organizations. The rotational equipment module 246 manages the use of selected equipment that is designated as rotational equipment. Rotational equipment is essentially a hardware resource that is on loan, and which will be eventually sold to a customer. The organization management module 248 creates and manages access to the database 256 and/or inventory 254 by the users of different organization sites. The item management module 250 creates new types of items that may be stored in the inventory repository 254. The inventory management module 251 allows a user to create and update inventory items. The reporting module 252 provides a variety of reports based on the information stored in the database 256 and/or inventory repository 254.

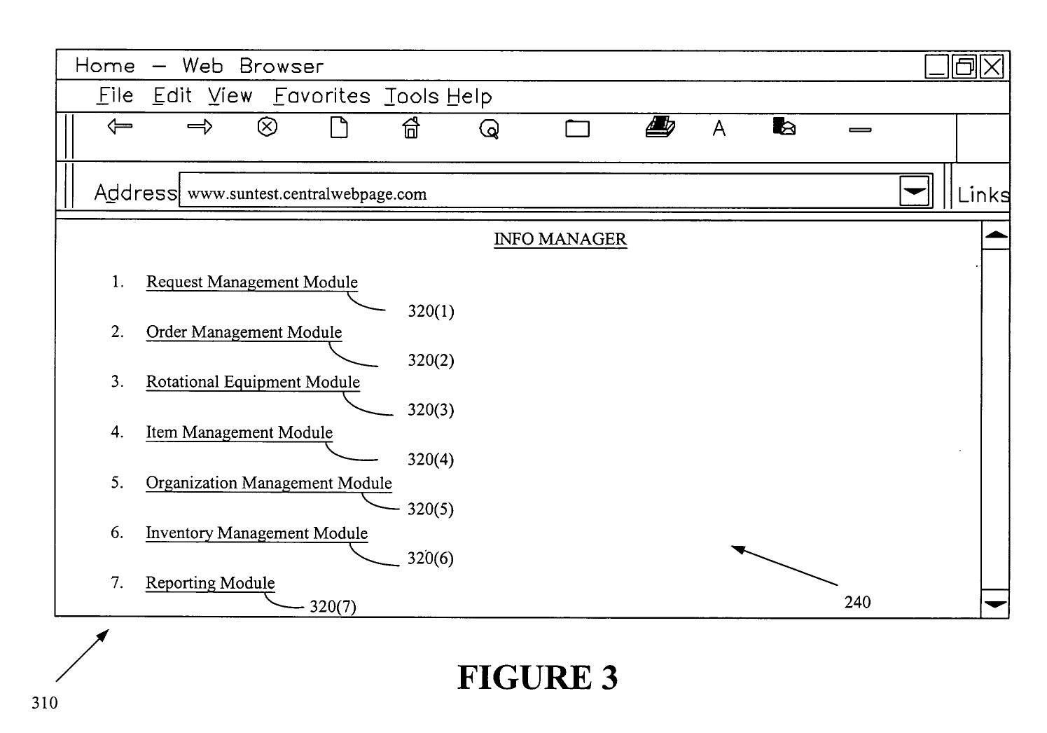

In the illustrated embodiment of the central system 15 of FIG. 2, although not so limited, the central web page module 240 is a hypertext markup language (html) file that contains one or more hyperlinks to one or more of the above-mentioned modules 242, 244, 246, 248, 250, 251, 252. FIG. 3 illustrates one embodiment of the central web page module 240, shown in a web browser window 310. As can be seen, the central web page module 25 240, which has an exemplary uniform resource locator (URL) of “www.suntest.centralwebpage.com,” includes one of a variety of selectable hyperlinks 320(1-7) through which the user may access menu screens of other modules 242, 244, 246, 248, 250, 251, 252.

The central web page module 240 may be viewed, for example, by users of the remote systems 20(1−n) using a web browser. A user may access one or more of the modules 242, 244, 246, 248, 250, 251, 252 from the central web page module 240 through the respective hyperlinks 320(1-7). For example, a user may select the first hyperlink 320(1) to access the request management module 242 (see FIG. 2). Similarly, other modules 244, 248, 250, 251, 252 may also be accessed through the respective hyperlinks 320(2-7). As is described in more detail below, the level of access granted to each user depends, in one embodiment, on the access rights granted to that particular user.

Referring again to FIG. 2, the central system 15 in the illustrated embodiment includes a display interface 265 and an input interface 267. The display interface 265 may be capable of interfacing with a display device 270 to display information on the display device 270. The input interface 267 may be capable of interfacing with input devices, such as a mouse 280 and/or a keyboard 285, to allow the user to input information into the central system 15.

Although in the illustrated embodiments, the web server module 220 and other modules 242, 244, 246, 248, 250, 251, 252 are shown residing on the central system 15, in alternative embodiments, one or more of these modules 220, 242, 244, 246, 248, 250, 251, 252 may reside on other systems that can be accessed by the central system 15 and remote systems 20(1−n). For example, the web server module 220 may reside on a system (not shown) controlled by the Internet service provider (ISP) of the central system 15. For ease of illustration, it is herein assumed that the web server module 220 and other modules 242, 244, 246, 248, 250, 251, 252 are stored locally on the central system 15.

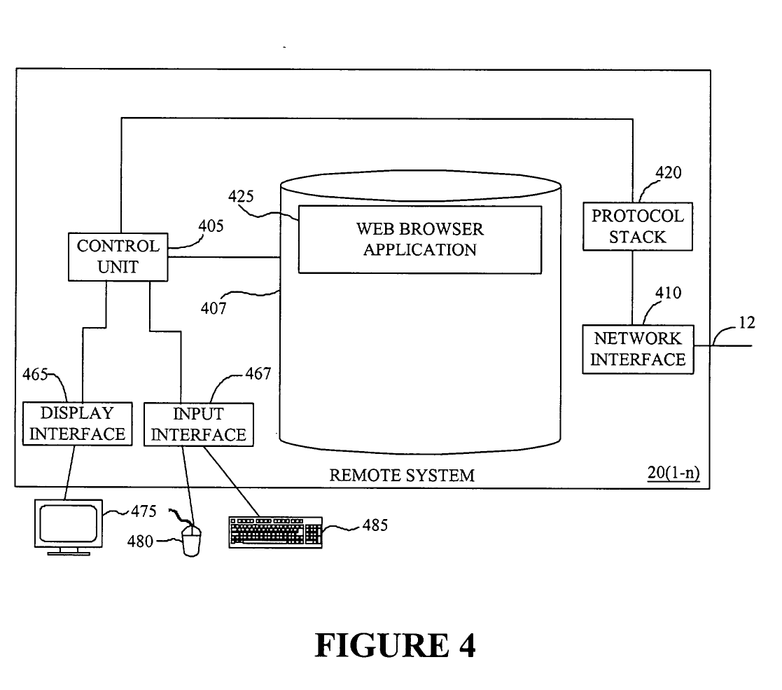

Referring now to FIG. 4, a block diagram of the remote system 20(1−n) of FIG. 1 in accordance with one embodiment of the present invention is illustrated. The remote system 20(1−n) includes a control unit 405 that is communicatively coupled to a storage unit 407. The remote system 20(1−n) includes a network interface 410 that provides the communications interface to the data network 12. Associated with the network interface 410 may be a network protocol stack 420, with one example being a UDP/IP stack. In one embodiment, both inbound and outbound packets may be passed through the network interface 410 and the network protocol stack 420.

The storage unit 407, in one embodiment, may include a web browser application 425 that is capable of receiving requests over the data network 12 and responding to such requests. In one embodiment, the remote system 20(1−n) includes a display interface 465 and an input interface 467. The display interface 465 may be capable of interfacing with a display device 475 to display information thereon. The input interface 467 may be capable of interfacing with input devices, such as a mouse 480 and/or a keyboard 485, to allow the user to input information into the remote system 20(1−n).

The arrangement shown in FIG. 4 is provided as an example only, as other embodiments can include other arrangements, which may include additional or fewer components. For example, the remote system 20(1−n) may include a bridge (not shown) between the control unit 405 and the interfaces 465, 467.

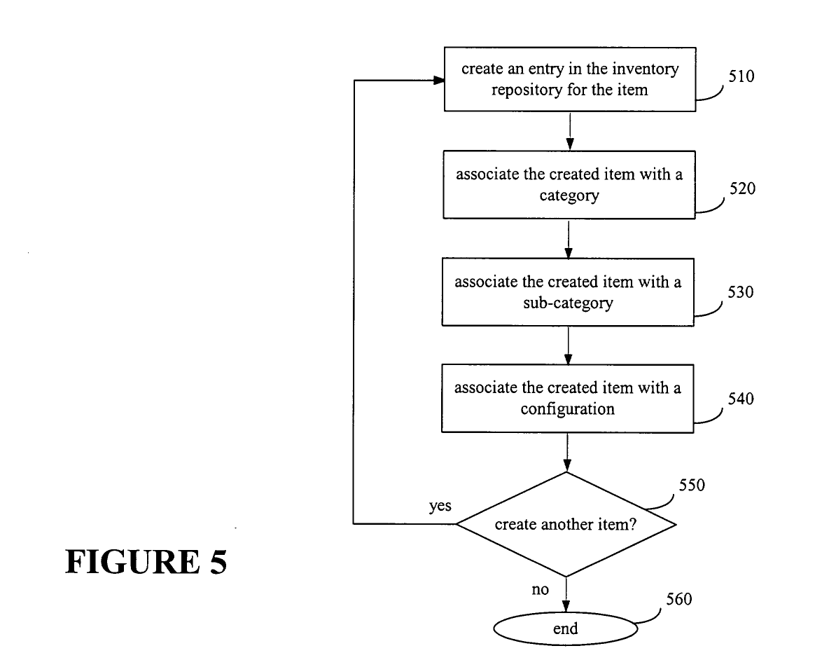

In the illustrated embodiment, and as described in more detail below, the inventory repository 254 may be updated in a variety of ways, including by the order management module 244, item management module 250, and inventory management module 251. A flow diagram of the item management module 250 is illustrated in FIG. 5, in accordance with one embodiment of the present invention. In creating entries for the inventory repository 254, a user, as an initial step, determines what items or resources are needed to complete the customer requests. For example, a user may determine that a network server having 64 megabytes of memory and four processors is needed to perform selected tasks desired by the customer. Accordingly, it may be desirable to create an entry for a network server in the inventory repository 254. The term “item,” as utilized herein, may include a hardware item, a software item, or any other tangible or quantifiable item.

Once the items that are needed to meet the desired objectives are determined, the user, via the item management module 250, creates (at 510) an entry in the inventory repository 254 for at least one of the items. The item management module 250 associates (at 520) the item created (at 510) with a category, where the category generally represents the class of the item, such as a “server,” “board,” and the like. In the illustrated embodiment, the item management module 250 further associates (at 530) the created item with a sub-category, where the sub-category further categorizes the item. For example, a particular server model (e.g., Sun Five® E10K by Sun Microsystems®) may belong to the “server” category. In one embodiment, the item management module 250 associates (at 540) the item created with a particular configuration. For example, the Sun Fire® E10K server may have an “E10K-64” configuration, which indicates that this E10K server is configured with 64 CPUs and 64 gigabytes of RAM.

The item management module 250 determines (at 550) whether the user desires to create additional items in the inventory repository 254. If the user desires to create additional inventory items, then the item management module 250 allows the user to create (at 510) the new inventory item. The above-described process may be repeated until the user has created all of the desired inventory items. The item management module 250 terminates (at 560) once the user has created the desired inventory items. The item management module 250 thus allows the user to create new inventory items. In one embodiment, although not shown, the item management module 250 may also allow the user to modify the created entries in the inventory repository 254.

In one embodiment, the inventory management module 251, similar to the item management module 250, allows a user to create and modify items in the inventory repository 254. The inventory management module 251 may also allow a user to make selected inventory items unavailable. Additionally, in one embodiment, the inventory management module 251 may be utilized to modify existing inventory records.

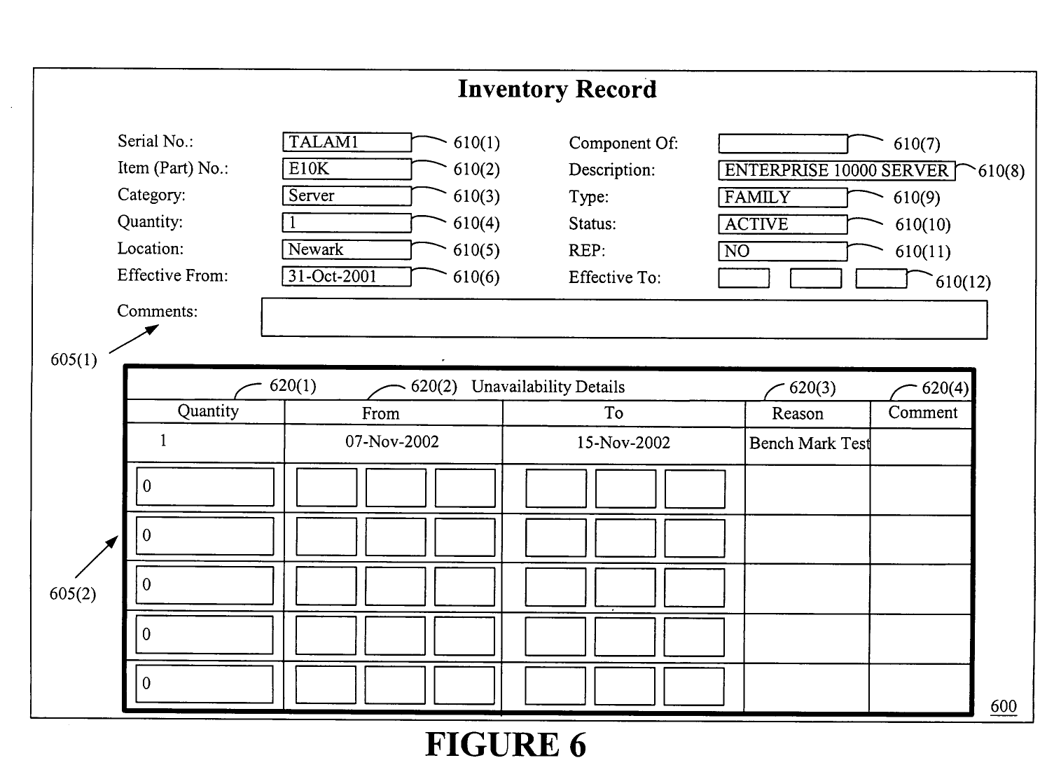

Referring now to FIG. 6, an exemplary inventory record 600 that may be created by the item management module 250 of FIG. 5 is illustrated, in accordance with one embodiment of the present invention. The inventory record 600, in the illustrated embodiment, includes two sections 605(1-2), although, in alternative embodiments, the inventory record 600 may include additional or fewer sections 605. The first section 605(1) includes a plurality of entries 610(1-12) that contain pertinent information regarding the inventory item that is associated with the inventory record 600. For example, the inventory item associated with the illustrated inventory record 600 is a server, as indicated in the entry 610(3) of the first section 605(1).

The entries 610(1-12) of the first section 605(1) include a variety of useful information associated with the server item. For example, the first entry 610(1) identifies the serial number of the server, while the second entry 610(2) identifies the “item type” (e.g., E10K) of the server. Similarly, other entries 610(4-12) contain other relevant information regarding the server (i.e., the inventory item), such as the quantity of the server(s), location of the server(s), effective date the server(s) is/are available for use, and the like.

The second section 605(2) provides information regarding the availability (or unavailability) of the item (e.g., server) associated with the inventory record 600. In the illustrated example of FIG. 6, for instance, the second section 605(2) indicates that the server item is unavailable from Nov. 7, 2002 to Nov. 15, 2002. In one embodiment, the system administrator may enter dates during which the inventory item may not be available. The availability of any particular item may depend on whether that item is reserved to perform benchmark requests, for example, that are submitted by customers.

The second section 605(2), in the illustrated embodiment, includes a plurality of fields 620, including the quantity field 620(1), unavailability date (i.e., “from” and “to”) field 620(2), reason field 620(3), and comment field 620(4). In other embodiments, fewer or additional fields 620 may be employed, depending on the implementation. In the illustrated embodiment, the quantity field 620(1) identifies the number of inventory items that are being reserved for the dates indicated by the unavailability date field 620(2). The reason field 620(3) may be utilized to indicate the reason the inventory item is unavailable for the duration specified in the unavailability date field 620(2). The comment field 620(4) may be utilized for providing any additional information regarding the reservation of the inventory item for the period specified by the unavailability date field 620(2).

Although the exemplary inventory record 600 shown in FIG. 6 is for a hardware inventory item (i.e., server), it should be appreciated that in other embodiments the inventory repository 254 may include other types of resources as well. For example, the inventory repository 254 may include an inventory record 600 for each facility (e.g., such as rooms, labs) that is available to perform benchmark requests at a given center of an organization. The inventory record 600, may, for example, identify a particular facility and the dates that facility is available or not available. The inventory repository 254, in one embodiment, may also include an inventory record 600 for each personnel resource (e.g., engineers, support staff, technicians) that is available at a particular center to perform the received benchmark requests. The inventory record 600 may, for example, identify a particular personnel member and may indicate the dates that the personnel member is available or not available. In one embodiment, the facility and personnel resources may each be stored in a separate inventory repository, if desired.

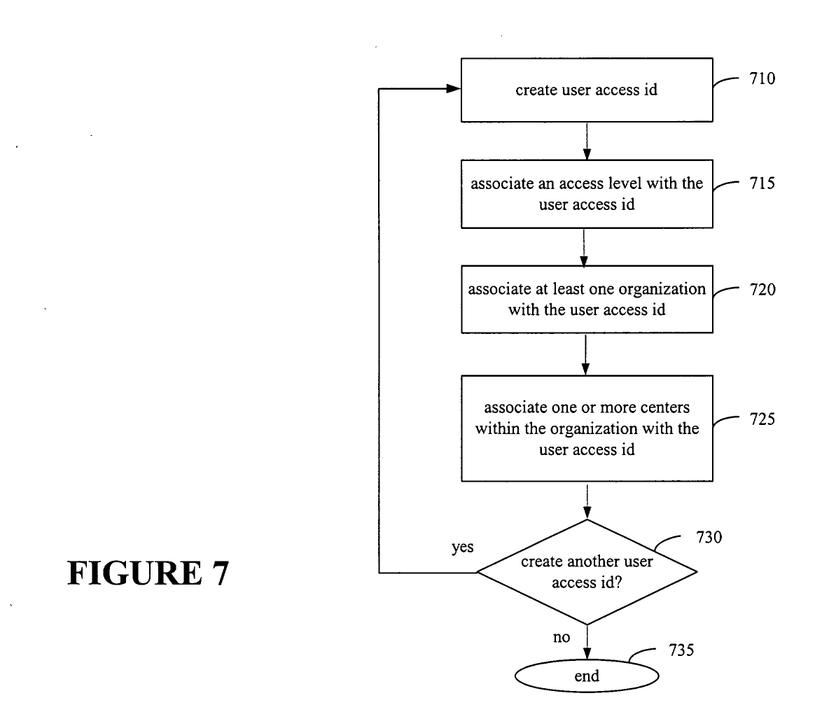

Referring now to FIG. 7, a flow diagram of the organization management module 248 of FIG. 2 is illustrated, in accordance with one embodiment of the present invention. Generally, the organization management module 248 allows a system administrator to create user access IDs that may be used by users to access selected modules of the central system 15. The organization management module 248 allows the administrator to create (at 710) a user access ID. The user access ID created (at 710) may then be associated (at 715) with an access level, where the “access level” defines the security access level that is granted to that user access ID. For example, the user access ID may be assigned an entry-level access, an administrator-level access, or any other user-defined intermediate level, depending on the level of access the administrator desires to grant to the user having the user access ID.

In the illustrated embodiment, the user access ID may be associated (at 720) with at least one organization, where one or more centers may belong to an organization. The organization management module 248 allows the administrator to associate (at 725) one or more centers within the organization with the user access ID. Thus, in one embodiment, each user access ID belongs to at least one center of at least one organization.

Referring again to FIG. 7, the organization management module 248 determines (at 730) if the administrator desires to create another user access ID. If the administrator desires to create additional user access IDs, then, in one embodiment, the acts of blocks 710-730 may be repeated to create the additional user access IDs. If it is determined (at 730) that the administrator does not desire to create any more user access IDs, the organization management module 248 terminates (at 735). In one embodiment, the act of terminating (at 735) may include passing control to the central web page, module 240 of FIG. 2.

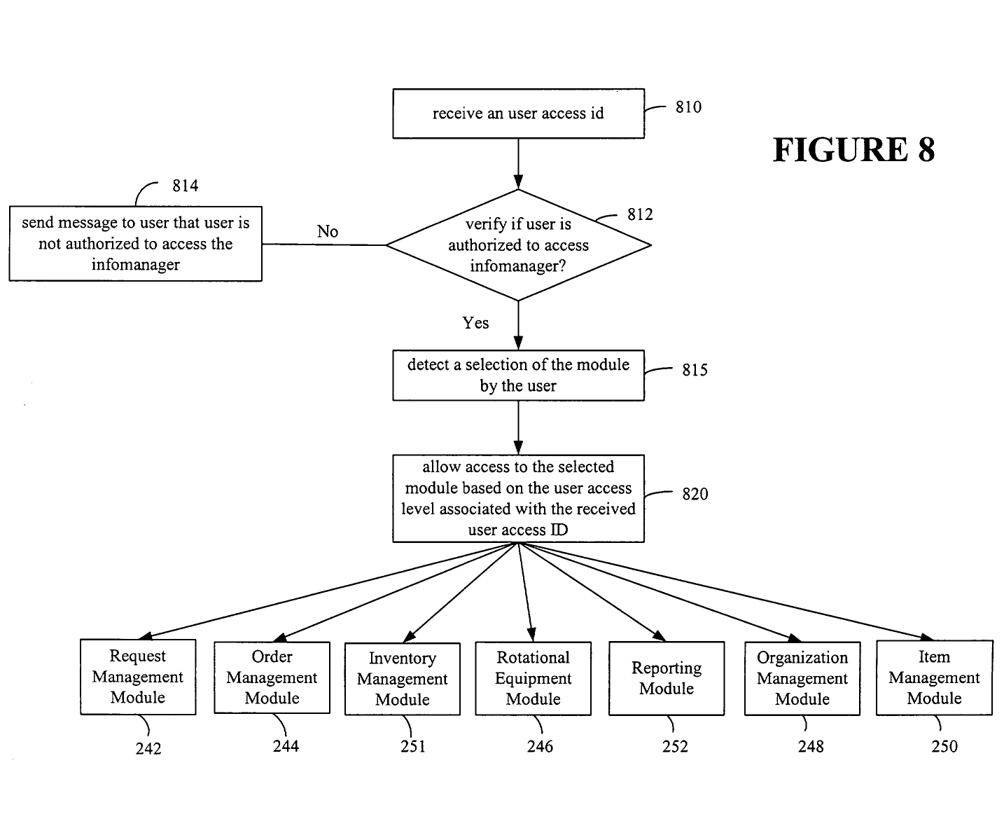

Referring now to FIG. 8, a flow diagram of a method of accessing the infomanager 257 (see FIG. 2) is illustrated. The infomanager 257 receives (at 810) a user access ID from a user attempting to access the infomanager 257. Receiving (at 810) the user access ID, in one embodiment, may also include receiving a password associated with the user access ID. The user access ID is verified (at 812) to determine if the user is authorized to access the infomanager 257. In the event the user is not authorized to access the infomanager 257, a message indicating that the access has been denied may be provided (at 814) to the user.

If it is determined (at 812) that user access ID is valid, then the user is allowed to access the infomanager 257. For example, in one embodiment, upon providing a valid user access ID, the user may be forwarded to the central web page module 240 of FIG. 3 from where the user may select one of a variety of hyperlinks 320(1-7) to access the various modules 242, 244, 246, 248, 250, 251, 252. The infomanager 257 detects (at 815) the module that is selected (via the hyperlink 320(1-7)) by the user. The infomanager 257 allows (at 820) access to the selected module based on the user access level associated with the received user access ID. That is, the level of access that is granted to the user depends on the security level associated with that user access ID. For example, a user access ID from one organization may not access to database contents associated with another organization. As shown in FIG. 8, the user, depending on the user access level associated with the user access ID, may select one or more modules 242, 244, 246, 248, 250, 251, 252.

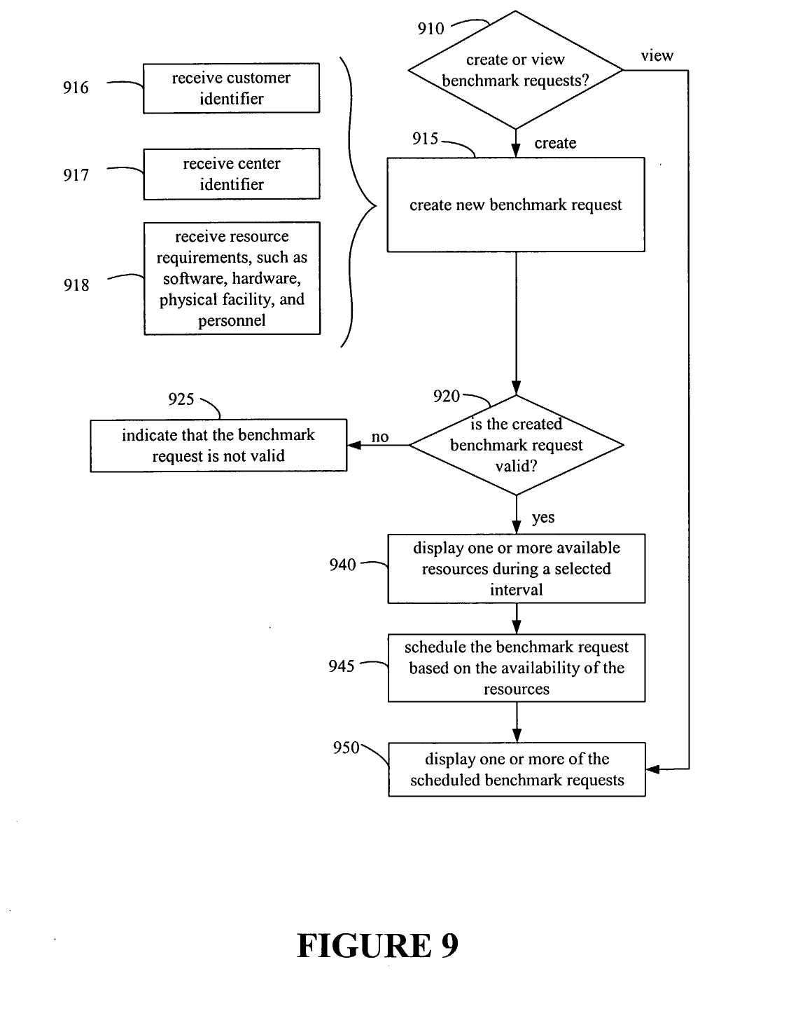

Referring now to FIG. 9, a flow diagram of the request management module 242 is illustrated. The request management module 242, in one embodiment, allows the user to create new or view existing (at 910) benchmark requests. If the user desires to create a benchmark request, the request management module 242 creates (at 915) the new benchmark request. Creating (at 915) the new benchmark request, in one embodiment, may include: receiving (at 916) customer identifier that, for example, identifies the customer that requested the benchmark request; receiving (at 917) the center identifier that, for instance, identifies the center that is to complete the benchmark request; receiving (at 918) resource requirements, such as software, hardware, physical facilities, and personnel that may be needed to complete the benchmark request.

Once a benchmark request has been created (at 915), the request management module 242 allows the administrator to determine (at 920) if the benchmark is valid. The benchmark request may not be valid for a variety of reasons depending on the organization's objectives. For example, a sales organization may consider the benchmark request to be invalid if the customer does not intend to purchase the product that comprises the benchmark request. If the benchmark request is determined to be invalid (at 920), then the request management module 242 indicates (at 925) as such via a message, for example, to the user.

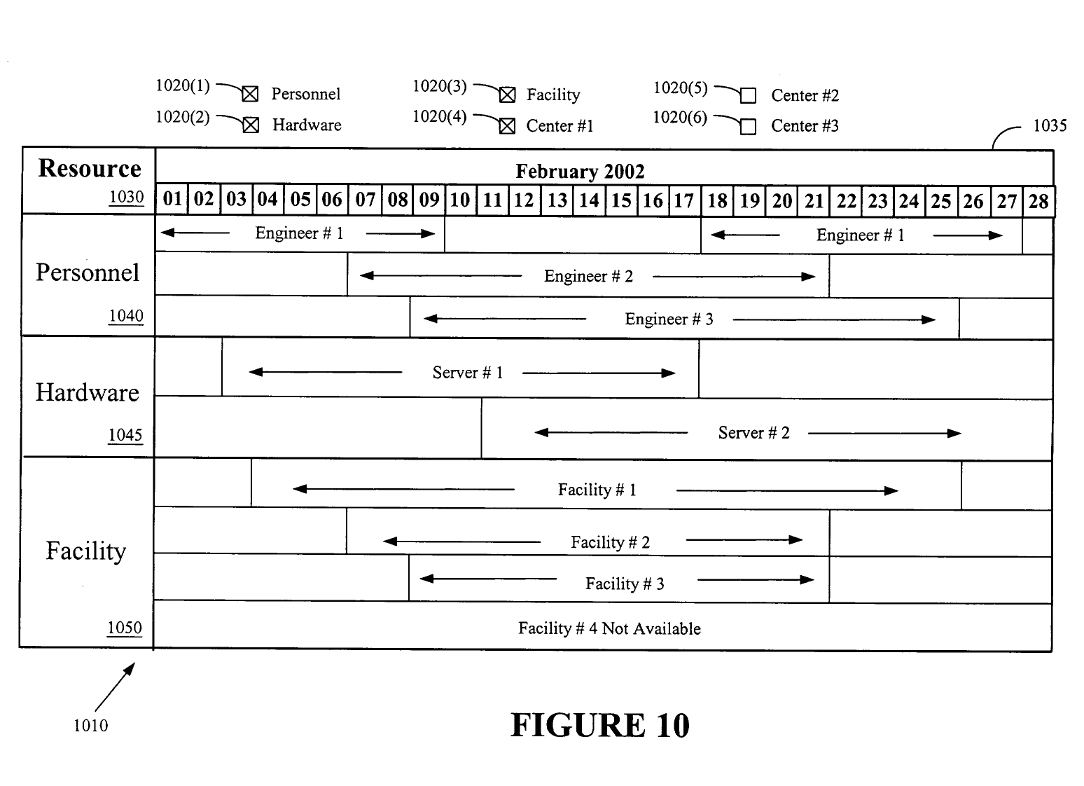

The request management module 242 displays (at 940) one or more of the resources that are available for use during a selected time interval or period. In one embodiment, and as explained in more detail below, the available resources may be displayed (at 940) in a calendar format, such that the user may see which resources are available on selected days. The user interested in scheduling a benchmark request may provide a range of dates, for example, to the request management module 242 to ascertain which resources are available for use during the days that fall within the range of dates. An exemplary format for displaying (at 940) the available resources is shown in FIG. 10, which is described in more detail below. Referring again to FIG. 9, upon displaying (at 940) the one or more of the available resources, the request management module 242 allows the user to schedule (at 945) the benchmark request.

In one embodiment, the request management module 242 may display (at 950) one or more of the scheduled benchmark requests for a user desiring to view (at 910) such requests. The scheduled benchmark requests may be shown in a calendar format such that the user may readily determine which benchmark requests have been scheduled and for what days.

Referring now to FIG. 10, an exemplary format for displaying one or more of the available resources that may be needed to complete the benchmark request is shown. In one embodiment, the available resources may be shown in a window 1010, which, for example, may be displayed by the request management module 242 on the display 270 (see FIG. 2) of the central system 15. In the illustrated embodiment, a plurality of selectable options 1020(1-6) is provided that allows the user to select the type of available resources to display for a selected center of an organization. For example, the first option 1020(1), when selected by the user, allows the user to view to a list of personnel (e.g., engineers, technicians) that are available during a selected time period to complete the benchmark request. Similarly, the second and third options 1020(2-3) allow the user to view the hardware and facilities, respectively, that are available to complete the benchmark request. In the illustrated embodiment, only the first four options 1020(1-4) are selected; accordingly, only the available personnel, hardware, and facilities for center #1 are shown in the window 1010. The available resources from other centers, such as from centers #2 and #3, may also be viewed by selecting the fifth and sixth options 1020(5-6).

In the illustrated embodiment, the window 1010 includes a resource column 1030 and a date column 1035. The resource column 1030 includes a variety of available resources that may be needed to complete the benchmark request. For example, the resource column 1030 includes a personnel section 1040, a hardware section 1045, and a facility section 1050. The date column 1035 illustrates the days the available resources listed in the resource column 1030 are available for a given time period, which, in the illustrated embodiment, is the month of February. The personnel section 1040, for example, illustrates that Engineer #1 is available from February 1 to February 9 and from February 18 to February 27, Engineer #2 is available from February 07 to February 21, and Engineer #3 is available from February 08 to February 26. Similarly, the hardware section 1045 and facility section 1050 illustrate the dates the servers and rooms, respectively, are available during the month of February.

The request management module 242, in one embodiment, determines the dates the available resources are available to complete the benchmark request based on the information that is stored in the unavailability date field 620(2) (see FIG. 6) of the inventory record 600. Based on the displayed available resources, the benchmark request may be schedule during any desirable period during which the resources are available.

It should be appreciated that the type and format of the information displayed in the window 1010 of FIG. 10 is exemplary in nature, and that in alternative embodiments, a variety of other types of information may be displayed in other graphical formats that are consistent with the spirit and scope of one or more embodiments of the present invention.

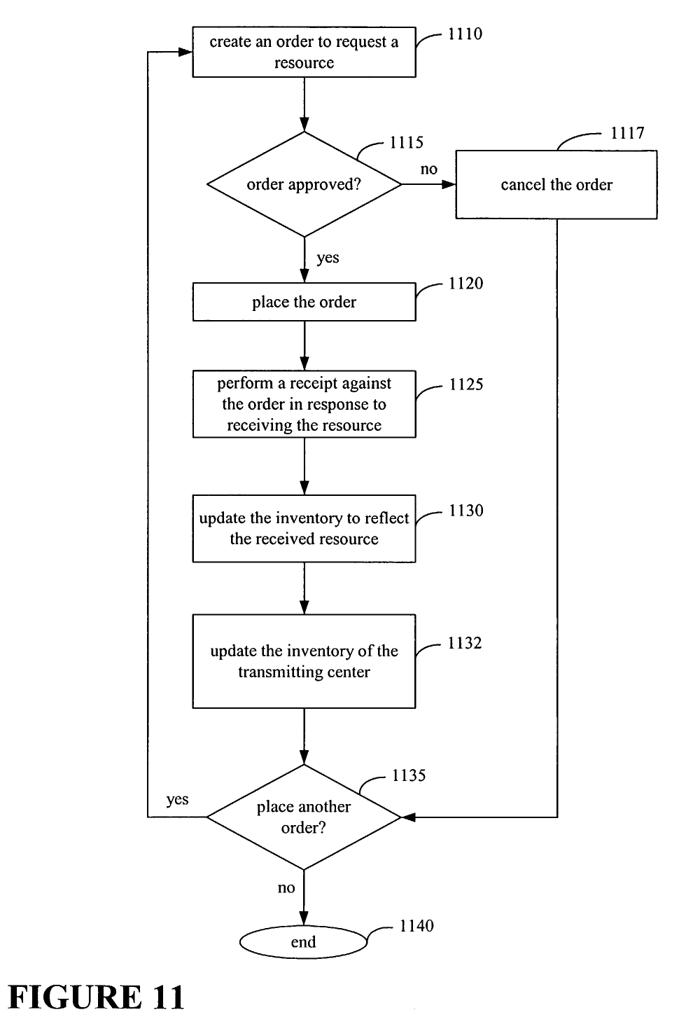

Referring now to FIG. 11, a flow diagram of the order management module 244 is illustrated. The order management module 244 generally tracks and processes inventory orders for various organizations. In one embodiment, the order management module 244 also manages intra-organization inventory transfers (i.e., between centers of the same organization). The order management module 244 allows a user to create (at 1110) an order to request a particular resource. The order management module 244, in one embodiment, allows the system administrator to approve or disapprove (at 1115) the created order. If the order is not approved, the order is cancelled (at 1117).

If the order is approved (at 1115), then the order management module 244 places (at 1120) the order. The order, once placed (at 1120), remains open until the requested resource is received. Once the received is received, the order management module 244 may be utilized to perform (at 1125) a receipt against the order to acknowledge the receipt of the resource. Performing (at 1125) the receipt against the order, in one embodiment, comprises correlating the received resource against the open order and then closing the order. The inventory repository 254 of the organization receiving the order is updated (at 1130) to reflect the received resource. For example, if the resource is received from another center within the same organization, the order management module 244 updates (at 1132) the inventory repository 254 of the transmitting organization as well. That is, in one embodiment, the inventory repository 254 of the center receiving the resource is incremented to reflect the added resource, while the inventory repository 254 of the transmitting center is decreased by one. Accordingly, in one embodiment, the inventory repository 254 of the transmitting center and the receiving center is updated only when the resource has arrived at the receiving center. As mentioned, in one embodiment, each center may have its own (i.e., separate) inventory repository 254 that is stored in the central system 15 (see FIG. 1). In one embodiment, messages, such as e-mail messages, may be transmitted between the transmitting and receiving centers to indicate that the transferred resource has arrived at its destination. One reason the inventory repository 254 of the transmitting center may be updated after the actual receipt of the resource by the receiving center because the inventory transfers for both of the centers are managed by the central system 15, in one embodiment.

The order management module 244 determines (at 1135) if the user desires to place another order. If so, the above process may be repeated, starting from block 1110. If, however, no more orders are desired, then the process terminates (at 1140).

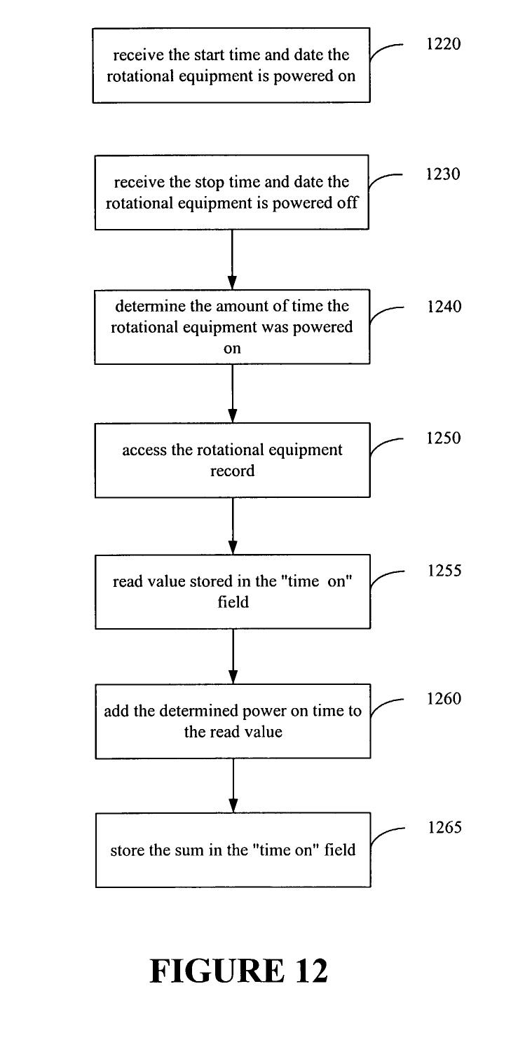

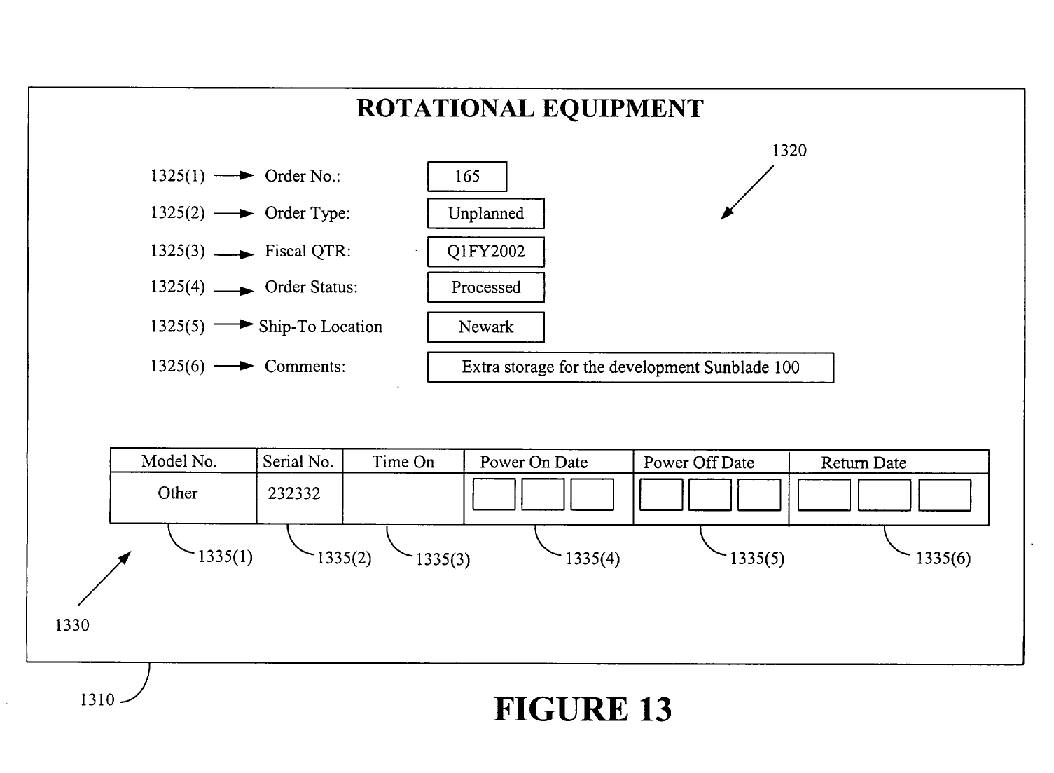

Referring now to FIG. 12, a flow diagram of the rotational equipment module 246 is illustrated. The rotational equipment module 246 manages the use of selected equipment that is designated as rotational equipment. Rotational equipment is essentially a hardware resource that is on loan, and which will be eventually sold to a customer. Because the equipment may eventually be sold to a customer, it is desirable to track the usage of such equipment. In one embodiment, each rotational equipment has an associated rotational equipment record that may be stored in the inventory repository 254. An exemplary rotational equipment record 1310 is shown in FIG. 13.

The rotational equipment record 1310 in the illustrated embodiment of FIG. 13 includes a first section 1320 that includes a plurality of fields 1325(1-6) that contain information that is pertinent to the rotational equipment, information such as the order number, order type, fiscal quarter or year, order status, location, and the like. The rotational equipment record 1310 includes a second section 1330 that includes a plurality of fields 1335(1-6) for tracking the amount of time the rotational equipment is in use (i.e., powered on). The fields 1335(1-6) may store information such as the model number, serial number, the total time the equipment is powered on, the power-on date, power-off date, and the date the equipment is returned.

Referring again to FIG. 12, the rotational equipment module 246 receives (at 1220) a start time and date the rotational equipment is powered on and receives (at 1230) a stop time and date the rotational equipment is powered off. The power-on and power-off times and dates may be stored, for example, in the fields 1335(4-5) of the rotational equipment record 1310 of FIG. 13.

The rotational equipment module 246 determines (at 1240) the amount of time the rotational equipment was powered on. The amount of time the rotational equipment was powered on may be determined (at 1240) by calculating the elapsed time between the start time and date and stop time and date that are received (at 1220 and 1230) by the rotational equipment module 246.

The rotational equipment module 246 accesses (at 1250) the rotational equipment record 1310 associated with the rotational equipment. The rotational equipment module 246 reads (at 1255) the value stored in the field 1335(3) (i.e., “time on” field) of the rotational equipment record 1310. The value read from the field 1335(3) is then added (at 1260) to the power-on time determined (at 1240) to arrive at a total time the rotational equipment has been powered on. The rotational equipment module 246 stores (at 1265) the total time in the field 1335(3) of the rotational equipment record 1310. Accordingly, the field 1335(3) identifies the total usage time for the rotational equipment.

The various system layers, routines, or modules may be executable control units (such as control unit 202, 405 (see FIGS. 2 and 4)). Each control unit 202, 405 may include a microprocessor, a microcontroller, a digital signal processor, a processor card (including one or more microprocessors or controllers), or other control or computing devices. The storage devices referred to in this discussion may include one or more machine-readable storage media for storing data and instructions. The storage media may include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy, removable disks; other magnetic media including tape; and optical media such as compact disks (CDs) or digital video disks (DVDs). Instructions that make up the various software layers, routines, or modules in the various systems may be stored in respective storage devices. The instructions when executed by a respective control unit 202, 405 cause the corresponding system to perform programmed acts.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed:

1. A method, comprising:
placing a request order to acquire at least one item from an inventory associated with a first location;
receiving the item;
providing an indication of receipt of the item; and
reducing the inventory associated with the first location in response to receiving the indication.

2. The method of claim 1, wherein providing an indication of receipt comprises providing an electronic mail message to indicate the receipt of the item.

3. The method of claim 1, wherein placing the request order comprises placing the request order from a second location to the first location to acquire the at least one item.

4. The method of claim 3, further comprising incrementing an inventory associated with the second location based on receiving the item.

5. The method of claim 4, further comprising scheduling the item to perform a benchmark request.

6. The method of claim 1, further comprising determining if the item is designated as rotational equipment.

7. The method of claim 6, further comprising tracking the usage time of the item.

8. The method of claim 1, wherein placing the request order comprises placing the request order in response to determining that the request order has been approved.

9. An article comprising one or more machine-readable storage media containing instructions that when executed enable a processor to:
provide an order to acquire a resource from a source, wherein the source includes a preselected number of resources;
provide an indication based on receiving the item; and
reduce the preselected number of resources by one based on detecting the indication.

10. The article of claim 9, wherein the instructions when executed enable the processor to provide the order from a first center to a second center to acquire the resource.

11. The article of claim 10, wherein the instructions when executed enable the processor to increment an inventory associated with the first center based on receiving the item.

12. The article of claim 9, wherein the instructions when executed enable the processor to schedule the resource to perform a benchmark request.

13. The article of claim 9, wherein the instructions when executed enable the processor to provide an electronic mail message based on receiving the resource.

14. The article of claim 9, wherein the instructions when executed enable the processor to determine if the resource is designated for a resale to a customer.

15. The article of claim 14, wherein the instructions when executed enable the processor to track the usage of the resource based on determining that the resource is designated for resale.

16. The article of claim 9, wherein the instructions when executed enable the processor to approve the order before providing the order to the source.

17. An apparatus, comprising:
means for placing a request order to acquire at least one item from an inventory associated with a first location;
means for receiving the item;
means for providing an indication of receipt of the item; and
means for reducing the inventory associated with the first location in response to receiving the indication.

18. An apparatus, comprising:
a storage unit comprising an inventory associated with a first location, wherein the inventory includes at least one item; and
a control unit communicatively coupled to the storage unit, the control unit adapted to:
provide a request to receive the item from the first location;
provide an indication based on receiving the item; and
adjust the number of items in the inventory based on detecting the indication.

19. The apparatus of claim 18, wherein the control unit is adapted to provide the request to transmit the item from the first location to a second location.

20. The apparatus of claim 19, wherein the storage unit includes an inventory associated with the second location.

21. The apparatus of claim 20, wherein the control unit is adapted to increment the inventory associated with the second location based on receiving the item at the second location.

22. The apparatus of claim 21, wherein the control unit is adapted to schedule the resource to perform a benchmark request.

23. The apparatus of claim 18, wherein the control unit is adapted to reduce the number of items in the inventory associated with the first location based on detecting the indication.

24. The apparatus of claim 18, wherein the control is adapted to provide, an electronic mail message based on receiving the item.

25. The apparatus of claim 18, wherein the control unit is adapted to approve the order before providing the request.

26. The apparatus of claim 18, wherein the control unit is further adapted to:
receive a benchmark request;
determine one or more resources that are desired to perform the benchmark request;
display the one more resources that are available for use during a selected time interval; and
schedule the available resources to perform the benchmark request at a desirable time within the selected time interval.
